(19) United States
(12) Patent Application Publication
(10) Pub. No.: US 2005/0170890 A1
(43) Pub. Date: Aug. 4, 2005

(54) Methods and apparatus for providing customized games and game content for a gaming apparatus

(76) Inventors: Richard E. Rowe, Incline Village, NV (US); Joseph R. Hedrick, Reno, NV (US); Ward Chilton, Reno, NV (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/767,808

(22) Filed: Jan. 29, 2004

(51) Int. Cl. A63F 13/00

(52) U.S. Cl. 463/42

(57) ABSTRACT

A gaming apparatus may include a display unit, a value input device and a controller operatively coupled to the display unit and the value input device. The controller may include a processor and a memory operatively coupled to the processor. The controller may be programmed to receive preference data relating to the preferences of a player, to select a game from a plurality of available games based upon the player preferences to provide a game selection comprising the selected game, to cause the display unit to generate a game selection display relating to the game selection, to cause the display unit to generate a game display and to determine a value payout associated with an outcome of the game. The game selection display may relate to a game from the game selection. The controller may also be programmed to select a game characteristic based upon the first player preferences.

### BACKGROUND

This patent is directed to a casino gaming apparatus, which could be either an individual gaming unit or a casino gaming unit having a plurality of gaming units, each gaming unit capable of providing customized games and customized game content to a player.

Conventional gaming units have employed player tracking devices. A player was assigned an identification unique to that particular player. The identification was read by a gaming unit to determine the identity of the player. In some cases personal information about the player could be displayed or read by the gaming unit. Information about the player was also gathered by the gaming unit. The player was information was associated with the player identification and stored in a memory. In a conventional gaming system, a network computer accumulated and analyzed data relating to the player. For example, data relating to the dollar amount and number of wagers made by a player, winnings received by a player, games played by a player and other gaming habits of a player were accumulated and analyzed. In some cases, the player information also included the name of the player, the address of the player, age of the player and other demographic information regarding the player. The player information was used for various purposes including marketing, game development, product placement, etc.

### SUMMARY OF THE INVENTION

In one aspect, the invention is directed to a gaming system which may include a network server and a gaming apparatus. The network server may include a gaming server controller having a processor and a memory operatively coupled to the processor. The network server controller may be programmed to receive request data relating to a request for a game, to receive preference data relating to the preferences of a first player, to select a game from a plurality of available games based upon the first player preferences and to provide the selected game in response to the request. The gaming apparatus may be operatively coupled to the network server, and may include a display unit capable of generating video images, a value input device and a gaming apparatus controller. The gaming apparatus controller may include a processor and a memory operatively coupled to the processor. The gaming apparatus controller may be programmed to provide the network server with the request data, to receive game selection data relating to the selected game, to cause the display unit to generate a game display relating to the selected game, and to determine a value payout associated with an outcome of the selected game.

In another aspect, the invention is directed to a gaming apparatus which may include a display unit, a value input device and a controller operatively coupled to the display unit and the value input device. The controller may include a processor and a memory operatively coupled to the processor. The controller may be programmed to receive preference data relating to preferences of a first player, to select a game from a plurality of available games based upon the first player preferences to provide a game selection comprising the selected game, to cause the display unit to generate a game selection display relating to the game selection, to cause the display unit to generate a game display and to determine a value payout associated with an outcome of the game. The game display may relate to a game from the game selection, poker, blackjack, slots, keno or bingo.

In a further aspect, the invention is directed to a gaming apparatus which may include a display unit, a value input device and a controller operatively coupled to the display unit and the value input device. The controller may include a processor and a memory operatively coupled to the processor. The controller may be programmed to receive preference data relating to preferences of a first player, to select a game characteristic from plurality of game characteristics based upon the first player preferences to provide a game characteristic selection comprising the selected game characteristic, to cause the display unit to generate a game characteristic selection display relating to the game characteristic selection to cause the display unit to generate a game display, to implement a game characteristic from the game characteristic selection in the game and to determine a value payout associated with an outcome of the game. The game display may relate to poker, blackjack, slots, keno or bingo.

In yet another aspect, the invention is directed to a gaming method which may include receiving identification data relating to the identity of a first player and receiving player profile data relating to a player profile associated with the player identity. The player profile may include preference data relating to preferences of the first player. The method may further include selecting a game from a plurality of available games based upon the first player preferences to provide a game selection comprising the selected game, causing a game selection display relating to the game selection to be generated, causing a game display to be generated and determining a value payout associated with an outcome of the game represented by the video image. The game display may represent a game from the game selection, poker, blackjack, slots, keno or bingo.

Additional aspects of the invention are defined by the claims of this patent.

### BRIEF DESCRIPTION OF THE DRAWINGS

FIG. 1 is a block diagram of an embodiment of a gaming system in accordance with the invention;

FIG. 2 is a perspective view of an embodiment of one of the gaming units shown schematically in FIG. 1;

FIG. 2A illustrates an embodiment of a control panel for a gaming unit;

FIG. 3 is a block diagram of the electronic components of the gaming unit of FIG. 2;

FIG. 4 is a flowchart of an embodiment of a main routine that may be performed during operation of one or more of the gaming units;

FIG. 5 is a flowchart of an alternative embodiment of a main routine that may be performed during operation of one or more of the gaming units;

FIG. 6 is a flowchart of an embodiment of a game suggestion routine that may be performed by one or more of the gaming units;

FIG. 7 is a flowchart of an alterative embodiment of a game suggestion routine that may be performed by one or more of the gaming units;

FIG. 8 is a flowchart of yet another alternative embodiment of a game suggestion routine that may be performed by one or more of the gaming units;

FIG. 9 is an illustration of an embodiment of a visual display that may be displayed during performance of the main routine of FIGS. 4 or 5;

FIG. 10 is an illustration of an embodiment of a visual display that may be displayed during performance of the video poker routine of FIG. 12;

FIG. 11 is an illustration of an embodiment of a visual display that may be displayed during performance of the video blackjack routine of FIG. 13;

FIG. 12 is a flowchart of an embodiment of a video poker routine that may be performed by one or more of the gaming units;

FIG. 13 is a flowchart of an embodiment of a video blackjack routine that may be performed by one or more of the gaming units;

FIG. 14 is an illustration of an embodiment of a visual display that may be displayed during performance of the slots routine of FIG. 14;

FIG. 15 is an illustration of an embodiment of a visual display that may be displayed during performance of the video keno routine of FIG. 15;

FIG. 16 is a flowchart of an embodiment of a slots routine that may be performed by one or more of the gaming units;

FIG. 17 is a flowchart of an embodiment of a video keno routine that may be performed by one or more of the gaming units;

FIG. 18 is an illustration of an embodiment of a visual display that may be displayed during performance of the video bingo routine of FIG. 16; and

FIG. 19 is a flowchart of an embodiment of a video bingo routine that may be performed by one or more of the gaming units.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

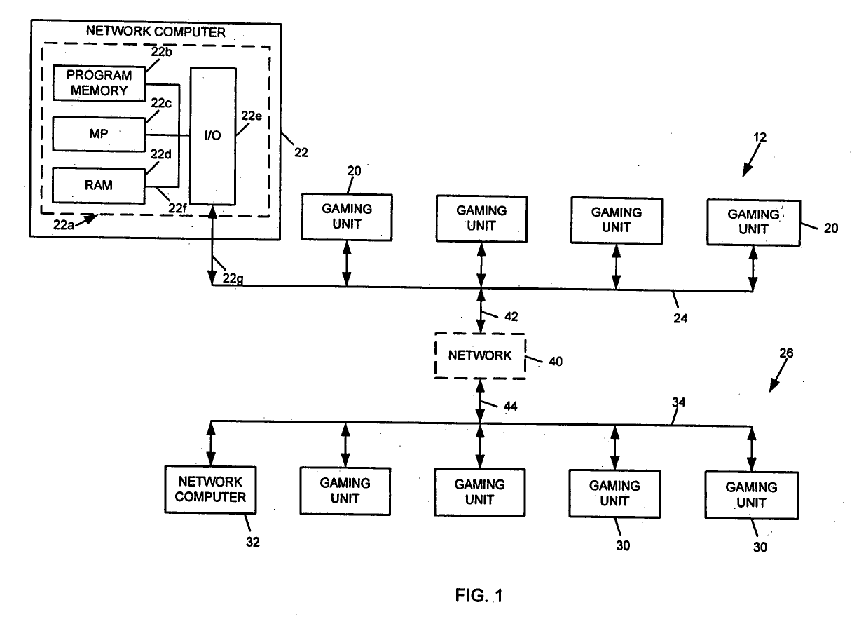

FIG. 1 illustrates one possible embodiment of a casino gaming system 10 in accordance with the invention. Referring to FIG. 1, the casino gaming system 10 may include a first group or network 12 of casino gaming units 20 operatively coupled to a network computer 22 via a network data link or bus 24. The casino gaming system 10 may include a second group or network 26 of casino gaming units 30 operatively coupled to a network computer 32 via a network data link or bus 34. The first and second gaming networks 12, 26 may be operatively coupled to each other via a network 40, which may comprise, for example, the Internet, a wide area network (WAN), or a local area network (LAN) via a first network link 42 and a second network link 44.

The first network 12 of gaming units 20 may be provided in a first casino, and the second network 26 of gaming units 30 may be provided in a second casino located in a separate geographic location than the first casino. For example, the two casinos may be located in different areas of the same city, or they may be located in different states. The network 40 may include a plurality of network computers or server computers (not shown), each of which may be operatively interconnected. Where the network 40 comprises the Internet, data communication may take place over the communication links 42, 44 via an Internet communication protocol.

The network computer 22 may be a server computer and may be used to accumulate and analyze data relating to the operation of the gaming units 20. For example, the network computer 22 may continuously receive data from each of the gaming units 20 indicative of the dollar amount and number of wagers being made on each of the gaming units 20, data indicative of how much each of the gaming units 20 is paying out in winnings, data regarding the identity and gaming habits of players playing each of the gaming units 20, etc. The network computer 22 may analyze the data regarding the gaming habits of players to customize games for a player, and/or to predict what games a player may enjoy. The network computer 22 may be used to store information regarding a particular player in a player profile. The player profile may include the wagering habits of the player, previous game selections, commonalities among previously selected games (e.g., game themes, potential payouts, game types, etc.), player game tactics and methods of play (e.g., aggressive), demographic information regarding the player such as age, gender, address, personal interests or any other information regarding the player. The network computer 32 may be a server computer and may be used to perform the same or different functions in relation to the gaming units 30 as the network computer 22 described above.

The network computer 22 may include a controller 22a that may comprise a program memory 22b, a microcontroller or microprocessor (MP) 22c, a random-access memory (RAM) 22d and an input/output (I/O) circuit 22e, all of which may be interconnected via an address/data bus 22f. It should be appreciated that although only one microprocessor 22c is shown, the controller 22a may include multiple microprocessors 22c. Similarly, the memory of the controller 22a may include multiple RAMs 22d and multiple program memories 22b. Although the I/O circuit 22e is shown as a single block, it should be appreciated that the I/O circuit 22e may include a number of different types of I/O circuits. The RAM(s) 22d and program memories 22b may be implemented as semiconductor memories, magnetically readable memories, and/or optically readable memories, for example.

Although the program memory 22b is shown in FIG. 1 as a read-only memory (ROM) 22b, the program memory of the controller 22a may be a read/write or alterable memory, such as a hard disk. In the event a hard disk is used as a program memory, the address/data bus 22f shown schematically in FIG. 1 may comprise multiple address/data buses, which may be of different types, and there may be an I/O circuit disposed between the address/data buses. The I/O circuit 22e may be coupled to the network 12 via a data link 22g. The network computer 32 may likewise include a controller similar to the controller 22a for the network computer 22.

Although each network 12, 26 is shown to include one network computer 22, 32 and four gaming units 20, 30, it should be understood that different numbers of computers and gaming units may be utilized. For example, the network 12 may include a plurality of network computers 22 and tens or hundreds of gaming units 20, all of which may be interconnected via the data link 24. The data link 24 may be provided as a dedicated hardwired link or a wireless link. Although the data link 24 is shown as a single data link 24, the data link 24 may comprise multiple data links.

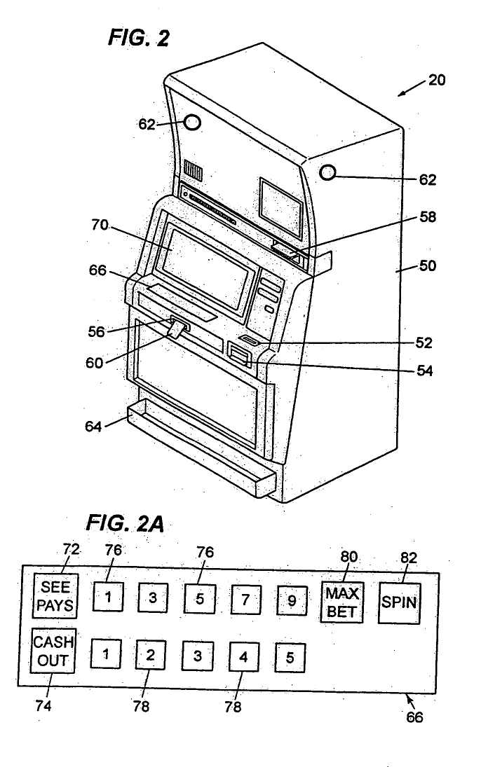

FIG. 2 is a perspective view of one possible embodiment of one or more of the gaming units 20. Although the following description addresses the design of the gaming units 20, it should be understood that the gaming units 30 may have the same design as the gaming units 20 described below. It should be understood that the design of one or more of the gaming units 20 may be different than the design of other gaming units 20, and that the design of one or more of the gaming units 30 may be different than the design of other gaming units 30. Each gaming unit 20 may be any type of casino gaming unit and may have various different structures and methods of operation. For exemplary purposes, various designs of the gaming units 20 are described below, but it should be understood that numerous other designs may be utilized.

Referring to FIG. 2, the casino gaming unit 20 may include a housing or cabinet 50 and one or more input devices, which may include a coin slot or acceptor 52, a paper currency acceptor 54, a ticket reader/printer 56 and a card reader 58, which may be used to input value to the gaming unit 20. A value input device may include any device that can accept value from a customer. As used herein, the term “value” may encompass gaming tokens, coins, paper currency, ticket vouchers, credit or debit cards, smart cards, and any other object representative of value.

If provided on the gaming unit 20, the ticket reader/printer 56 may be used to read and/or print or otherwise encode ticket vouchers 60. The ticket vouchers 60 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 60 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 60 could be printed with an optically readable material such as ink, or data on the ticket vouchers 60 could be magnetically encoded. The ticket reader/printer 56 may be provided with the ability to both read and print ticket vouchers 60, or it may be provided with the ability to only read or only print or encode ticket vouchers 60. In the latter case, for example, some of the gaming units 20 may have ticket printers 56 that may be used to print ticket vouchers 60, which could then be used by a player in other gaming units 20 that have ticket readers 56.

If provided, the card reader 58 may include any type of card reading device, such as a magnetic card reader or an optical card reader, and may be used to read data from a card offered by a player, such as a credit card or a player tracking card. If provided for player tracking purposes, the card reader 58 may be used to read data from, and/or write data to, player tracking cards that are capable of storing data representing the identity of a player, the identity of a casino, the player's general gaming habits, etc. The data may further represent games previously wagered on by the player, including various aspects or characteristics of each of those games (e.g., a game theme, type of game, potential payout amount, multiplayer/single player, etc.). The player's gaming habits may be specifically related to each game previously wagered on by the player. For example, the data may represent the number of wagers per game, frequency of play per game, amount of time spent per game, the date and time each game was played, tactics, play methodology, etc. As mentioned, just as the card reader 58 may be used to read player tracking data from a card offered by a player, the gaming unit 20 may also use the card reader 58 to write player tracking data to the player tracking card. In other examples, such information may be stored the network computer 22 and accessed by the gaming unit 20 when the card reader 58 reads a player identification on the player tracking card. That is, when the identity of a player is determined, the gaming unit 20 may read and/or write data relating to the player to/from the network computer 22 or other central memory device accessible by the gaming unit 20. Although a player tracking card has been mentioned, those of ordinary skill in the art will readily recognize that other methods and apparatus may be utilized to identify a player and associate the player with the data identified above.

The gaming unit 20 may include one or more audio speakers 62, a coin payout tray 64, an input control panel 66, and a display unit 70. Where the gaming unit 20 is designed to facilitate play of a video casino game, such as video poker or video slots, the display unit 70 may be a color video display unit that displays images relating to the particular game or games. Where the gaming unit 20 is designed to facilitate play of a reel-type slot machine, the display unit 70 may comprise a plurality of mechanical reels that are rotatable, with each of the reels having a plurality of reel images disposed thereon. The audio speakers 62 may generate audio representing sounds such as the noise of spinning slot machine reels, a dealer's voice, music, announcements or any other audio related to a casino game. The input control panel 66 may be provided with a plurality of pushbuttons or touch-sensitive areas that may be pressed by a player to select games, make wagers, make gaming decisions, etc.

FIG. 2A illustrates one possible embodiment of the control panel 66, which may be used where the gaming unit 20 is a slot machine having a plurality of mechanical or “virtual” reels. Referring to FIG. 2A, if the display unit 70 is provided in the form of a video display unit, the control panel 66 may include a “See Pays” button 72 that, when activated, causes the display unit 70 to generate one or more display screens showing the odds or payout information for the game or games provided by the gaming unit 20. As used herein, the term “button” is intended to encompass any device that allows a player to make an input, such as an input device that must be depressed to make an input selection or a display area that a player may simply touch. The control panel 66 may include a “Cash Out” button 74 that may be activated when a player decides to terminate play on the gaming unit 20, in which case the gaming unit 20 may return value to the player, such as by returning a number of coins to the player via the payout tray 64.

If the gaming unit 20 provides a slots game having a plurality of reels and a plurality of paylines which define winning combinations of reel symbols, the control panel 66 may be provided with a plurality of selection buttons 76, each of which allows the player to select a different number of paylines prior to spinning the reels. For example, five buttons 76 may be provided, each of which may allow a player to select one, three, five, seven or nine paylines.

If the gaming unit 20 provides a slots game having a plurality of reels, the control panel 66 may be provided with a plurality of selection buttons 78 each of which allows a player to specify a wager amount for each payline selected. For example, if the smallest wager accepted by the gaming unit 20 is a quarter ($0.25), the gaming unit 20 may be provided with five selection buttons 78, each of which may allow a player to select one, two, three, four or five quarters to wager for each payline selected. In that case, if a player were to activate the “5” button 76 (meaning that five paylines were to be played on the next spin of the reels) and then activate the “3” button 78 (meaning that three coins per payline were to be wagered), the total wager would be $3.75 (assuming the minimum bet was $0.25).

The control panel 66 may include a “Max Bet” button 80 to allow a player to make the maximum wager allowable for a game. In the above example, where up to nine paylines were provided and up to five quarters could be wagered for each payline selected, the maximum wager would be 45 quarters, or $11.25. The control panel 66 may include a spin button 82 to allow the player to initiate spinning of the reels of a slots game after a wager has been made.

In FIG. 2A, a rectangle is shown around the buttons 72, 74, 76, 78, 80, 82. It should be understood that that rectangle simply designates, for ease of reference, an area in which the buttons 72, 74, 76, 78, 80, 82 may be located. Consequently, the term “control panel” should not be construed to imply that a panel or plate separate from the housing 50 of the gaming unit 20 is required, and the term “control panel” may encompass a plurality or grouping of player activatable buttons.

Although one possible control panel 66 is described above, it should be understood that different buttons could be utilized in the control panel 66, and that the particular buttons used may depend on the game or games that could be played on the gaming unit 20. If the display unit 70 is provided as a video display unit, the control panel 66 could be generated by the display unit 70. In that case, each of the buttons of the control panel 66 could be a colored area generated by the display unit 70, and some type of mechanism may be associated with the display unit 70 to detect when each of the buttons was touched, such as a touch-sensitive screen.

### Gaming Unit Electronics

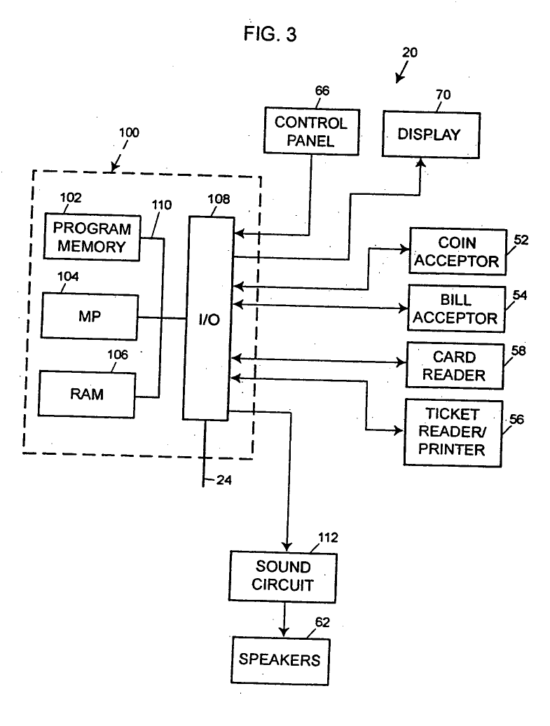

FIG. 3 is a block diagram of a number of components that may be incorporated in the gaming unit 20. Referring to FIG. 3, the gaming unit 20 may include a controller 100 that may comprise a program memory 102, a microcontroller or microprocessor (MP) 104, a random-access memory (RAM) 106 and an input/output (I/O) circuit 108, all of which may be interconnected via an address/data bus 110. It should be appreciated that although only one microprocessor 104 is shown, the controller 100 may include multiple microprocessors 104. Similarly, the memory of the controller 100 may include multiple RAMs 106 and multiple program memories 102. Although the I/O circuit 108 is shown as a single block, it should be appreciated that the I/O circuit 108 may include a number of different types of I/O circuits. The RAM(s) 104 and program memories 102 may be implemented as semiconductor memories, magnetically readable memories, and/or optically readable memories, for example.

Although the program memory 102 is shown in FIG. 3 as a read-only memory (ROM) 102, the program memory of the controller 100 may be a read/write or alterable memory, such as a hard disk. In the event a hard disk is used as a program memory, the address/data bus 110 shown schematically in FIG. 3 may comprise multiple address/data buses, which may be of different types, and there may be an I/O circuit disposed between the address/data buses.

FIG. 3 illustrates that the control panel 66, the coin acceptor 52, the bill acceptor 54, the card reader 58 and the ticket reader/printer 56 may be operatively coupled to the I/O circuit 108, each of those components being so coupled by either a unidirectional or bidirectional, single-line or multiple-line data link, which may depend on the design of the component that is used. The speaker(s) 62 may be operatively coupled to a sound circuit 112, that may comprise a voice- and sound-synthesis circuit or that may comprise a driver circuit. The sound-generating circuit 112 may be coupled to the I/O circuit 108.

As shown in FIG. 3, the components 52, 54, 56, 58, 66, 112 may be connected to the I/O circuit 108 via a respective direct line or conductor. Different connection schemes could be used. For example, one or more of the components shown in FIG. 3 may be connected to the I/O circuit 108 via a common bus or other data link that is shared by a number of components. Furthermore, some of the components may be directly connected to the microprocessor 104 without passing through the I/O circuit 108.

### Overall Operation of Gaming Unit

One manner in which one or more of the gaming units 20 (and one or more of the gaming units 30) may operate is described below in connection with a number of flowcharts which represent a number of portions or routines of one or more computer programs, which may be stored in one or more of the memories of the controller 100. The computer program(s) or portions thereof may be stored remotely, outside of the gaming unit 20, and may control the operation of the gaming unit 20 from a remote location. Such remote control may be facilitated with the use of a wireless connection, or by an Internet interface that connects the gaming unit 20 with a remote computer (such as one of the network computers 22, 32) having a memory in which the computer program portions are stored. The computer program portions may be written in any high level language such as C, C++, C#, Java or the like or any low-level assembly or machine language. By storing the computer program portions therein, various portions of the memories 102, 106 are physically and/or structurally configured in accordance with computer program instructions.

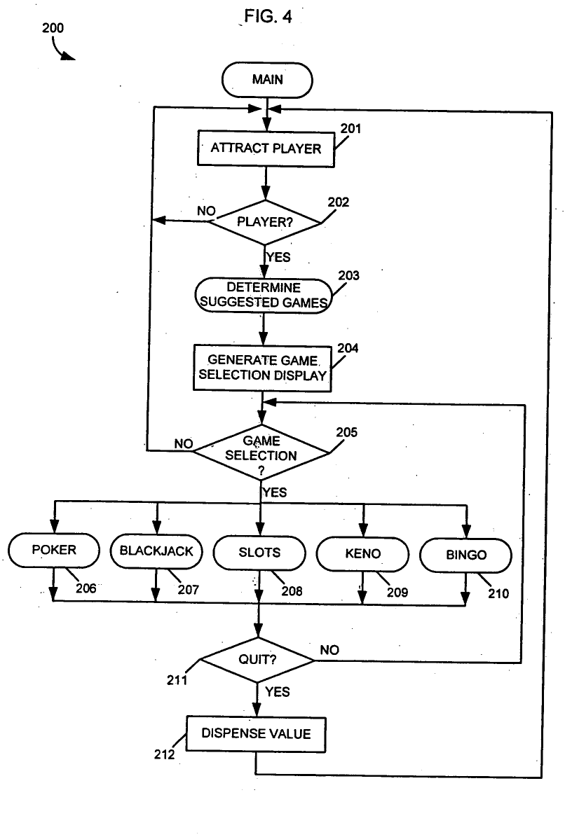

FIG. 4 is a flowchart of a main operating routine 200 that may be stored in the memory of the controller 100. Referring to FIG. 4, the main routine 200 may begin operation at block 201 during which an attraction sequence may be performed in an attempt to induce a potential player in a casino to play the gaming unit 20. The attraction sequence may be performed by displaying one or more video images on the display unit 70 (if provided as a video display unit) and/or causing one or more sound segments, such as voice or music, to be generated via the speakers 62. The attraction sequence may include a scrolling list of games that may be played on the gaming unit 20 and/or video images of various games being played, such as video poker, video blackjack, video slots, video keno, video bingo, etc.

During performance of the attraction sequence, if a potential player makes any input to the gaming unit 20 as determined at block 202, the attraction sequence may be terminated and suggested games may be determined at block 203 based on player preferences. The gaming unit 20 may detect an input at block 202 in various ways. For example, the gaming unit 20 could detect if the player presses any button on the gaming unit 20; the gaming unit 20 could determine if the player deposited one or more coins into the gaming unit 20; the gaming unit 20 could determine if player deposited paper currency into the gaming unit; etc.

The suggested games at block 203 may be determined based on player preferences associated with a player identification (e.g., a player profile). The player profile may be stored on memory within the gaming unit 20, or on a memory that may be remotely accessed by the gaming unit 20. The player profile may also be stored on a memory or other data storage device that the player may use for player identification, such as the player tracking card mentioned above. Using the player preferences, the gaming unit 20 may determine what games the player may enjoy and suggest resulting games to the player. The player preferences may also be used to determine game themes, potential payouts, game types or other game characteristics the player may enjoy. Alternatively, the gaming unit may provide the network computer 22 with the player identification, and the network computer 22 may determine suggested games for the player. Although suggested games may be determined at block 203, the gaming unit 20 may further provide default games in addition to, or as an alternative to, the suggested games determined at block 203.

A game-selection display may be generated in the display unit 70 (if provided as a video display unit) at block 204 to allow the player to select a game available on the gaming unit 20. The game-selection display generated at block 204 may include, for example, a list of video games that may be played on the gaming unit 20 and/or a visual message to prompt the player to deposit value into the gaming unit 20. The list of video games may include any suggested games as determined at block 203 and/or any default games that may otherwise be provided by the gaming unit 20. While the game-selection display is generated, the gaming unit 20 may wait for the player to make a game selection. Upon selection of one of the games by the player as determined at block 205, the controller 100 may cause one of a number of game routines to be performed to allow the selected game to be played. For example, the game routines could include a video poker routine 206, a video blackjack routine 207, a slots routine 208, a video chino routine 209, and a video bingo routine 210, or any other game listed on the game selection display from block 204. At block 205, if no game selection is made within a given period of time, the operation may branch back to block 201.

After one of the routines 206, 207, 208, 209, 210 has been performed to allow the player to play one of the games, block 211 may be utilized to determine whether the player wishes to terminate play on the gaming unit 20 or to select another game. If the player wishes to stop playing the gaming unit 20, which wish may be expressed, for example, by selecting a “cash out” button, the controller 100 may dispense value to the player at block 212 based on the outcome of the game or games played by the player. The operation may then return to block 201. If the player did not wish to quit as determined at block 211, the routine may return to block 205 where the game selection display may again be generated to allow the player to select another game.

It should be noted that although five gaming routines are shown in FIG. 4, a different number of routines could be included to allow play of a different number of games. The gaming unit 20 may also be programmed to allow play of different games, and may further be programmed to allow remote play of the game wherein the routine may be executed by the network computer 22, or another remote computer or server.

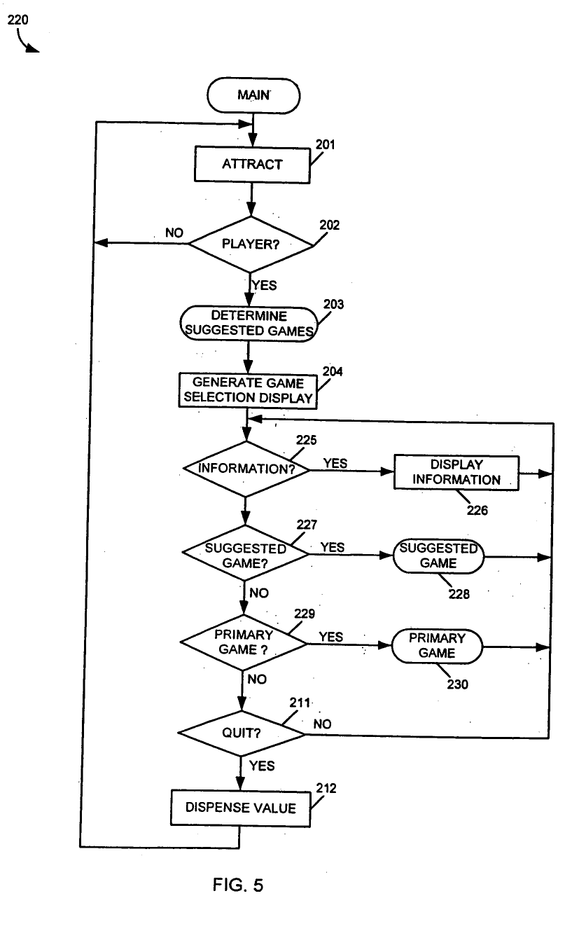

FIG. 5 is a flowchart of an alternative main operating routine 220 that may be stored in the memory of the controller 100. The main routine 220 may be utilized for gaming units 20 that are designed to allow play of only a single game or a single type of game. In the present example, the main routine 220 provides a player with the opportunity to either play a default game provided by the gaming unit 20 or to provide a game suggested by the gaming unit 20 (or network computer 22). Referring to FIG. 5, the main routine 220 may begin operation at block 201 during which an attraction sequence may be performed in the attempt to induce a potential player in a casino to play the gaming unit 20. The attraction sequence may be performed by displaying one or more video images on the display unit 70 (if provided as a video display unit) and/or causing one or more sound segments, such as voice or music, to be generated via the speakers 62.

During performance of the attraction sequence, if a potential player makes any input to the gaming unit 20 as determined at block 202, a suggested game may be determined at block 203. The suggested game may be determined based on player preferences associated with a player identification as read by the gaming unit 20. A game selection display may be generated on the display unit 70 (if provided as a video display unit) at block 204. The game selection display generated at block 204 may include, for example, an image of the default game and/or suggested games that may be played on the gaming unit 20 and/or a visual message to prompt the player to deposit value into the gaming unit 20. At block 225, the gaming unit 20 may determine if the player requested information concerning a game, in which case the requested information may be displayed at block 226. Block 227 may be used to determine if the player requested initiation of the suggested game determined at block 203, in which case a game routine 228 of the suggested game may be performed. The game routine 228 could be any of the game routines disclosed herein, such as one of the five game routines 206, 207, 208, 209, 210, or any other game routine.

Block 229 may be used to determine if the player requested initiation of a default game provided by the gaming unit 20, in which case a game routine of the default game provided by the gaming unit 20 may be performed. The default game routine 230 could be any of the game routines disclosed here, such as one of the five game routines 206, 207, 208, 209, 210, or any other default game routine. In an alternative example, a default game may not be provided by the gaming unit 20, and the only game provided may be the suggested game determined at block 203.

After the routines 228, 230 have been performed to allow the player to play a game, block 211 may be utilized to determine whether the player wishes to terminate play on the gaming unit 20. If the player wishes to stop playing the gaming unit 20, which wish may be expressed, for example, by selecting a “cash out” button, the controller 100 may dispense value to the player at block 212 based on the outcome of the game or games played by the player. The operation may then return to block 211. If the player did not wish to quit as determined at block 212, the operation may return to block 225.

Although the main operating routines 200, 220 have been disclosed as determining suggested games at blocks 203, respectively, those of ordinary skill in the art will recognize that the main operating routines 200, 220 may determine suggested game characteristics based on the player preferences such as game theme, potential payout, game types, etc. which may be used to customize a default game or to create a customized game. As explained below, player preferences regarding themes, potential payout, etc. may be used to determine the suggested game.

### Game Suggestion

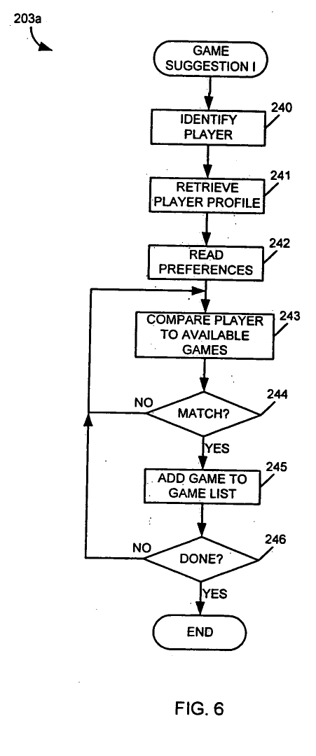

FIG. 6 is a flowchart of a first embodiment of a game suggestion routine 203a that may be stored in the memory of the controller 100 and/or a memory of the network computer 22. The game suggestion routine 203a may be performed during block 203 shown schematically in FIGS. 4 and 5 to determine what games a player may enjoy playing based on the player's preferences. Those of ordinary skill in the art will recognize that the routines described herein may likewise be utilized to determine game themes, payout tables, types of games, or other game characteristics based on player preferences.

Referring to FIG. 6, the game suggestion routine 203a may begin operation at block 240 during which a player may be identified. The player may be identified using any number of methods or apparatus, including, but not limited to, a player tracking card being read by the card reader 58. When the player has been identified at block 240 the routine 203a may retrieve an associated player profile at block 241. The player profile may be retrieved from a memory device which may be included in the player tracking card or other identifying device, retrieved from a memory of the controller 100, or retrieved from a central database.

The player profile may contain information about the player including the player's gaming preferences which may be read at block 242. The player preferences may include and/or be derived from demographic information about the player, the player's gaming habits, previous games played by the player, preferences dictated by the player, or other forms of player preferences and personal information. This information may be gathered in a variety of methods, such as polling the player for personal or demographic information (e.g., age, gender, income, personal finance, employment, residence, etc.), as well as the player's likes and dislikes regarding different games or characteristics of a game such as game format, game theme, type of game, game visuals, payout tables, or other game characteristics. The player may also be asked to rank which preferences are more important (e.g., game type is more important than game theme) and to rank each of these preferences with respect to each other (e.g., prefers both card game types and slot game types, but prefers slot game types). In effect, the player's preferences can be obtained at any desired level of detail from the most basic of information, such as demographic information, to more personalized preferences such as game type, game theme, etc.

In order to gather personal information about the player, a variety of techniques may be employed, whether alone or in combination. The player may be asked to answer a series of questions when receiving a player tracking card or other identification device, when first using a gaming unit 20, when first entering a casino, when first checking into a casino hotel, etc. This may be done via a hard copy questionnaire, via a questionnaire over a gaming unit 20, via a questionnaire over a video display kiosk, etc. Various other methods of determining a player's preferences may also be used, such as prompting the player to rank interest in various games, game themes, game types, etc.

The player's preferences may further be determined based on monitoring the player's gaming habits to allow for continual upgrading and refinement in establishing a player's preferences. For example, a player may prefer particular games based on game theme, game type, potential payout, etc., and may tend to play games that only have these particular characteristics. This may be determined by monitoring games played by the player, how long and how often a player plays a particular game, the size and/or number of wagers made for a particular game, selections made during a game, play tactics, etc. The gaming unit 20 may further query the player to determine how the player liked the various characteristics of a game. Other considerations may also be taken into account. For instance, the player's gaming habits may vary over periods of time (e.g., gaming habits on a weekday are different than gaming habits on a weekend), vary depending on the player's mood, vary depending on previous payouts received by the player or any other number of factors. The gaming unit 20 may monitor this behavior and provide such information to a computer or server, such as the network computer 22 or other data storage device. The network computer 22 or controller 100 may determine the player's gaming habits based on this information, which may be used to determine the player's preferences regarding particular games.

Previous games played by a player may also be used to determine the player's preferences. For example, the player profile may contain a record of the last game played by a player, the games most frequently played by a player or all games that have been played by the player. Each game may include a game profile that identifies various characteristics about a game. For example, a poker game, such as five card poker, may be associated with a game profile that depicts the game type (e.g., card game, poker), the minimum bet amount, the potential payout (e.g., dollar amount, high payout, low payout, etc.), game theme (e.g., sports, game shows, movies, etc.), multiplayer or single player games, etc. The characteristics for a particular game may depend on the game type. For example, a game profile for a slots game may include the number of pay lines available, a game profile for a Keno game may include the range of numbers, a game profile for a bingo game may include the game card choices, the game profile for a blackjack game may include the number of blackjack hands that may be played, etc. As seen from these examples, those of ordinary skill in the art will recognize that various other game characteristics may be included in each game profile with corresponding player preferences being determined for each player profile (e.g., preferred game type, preferred game theme, preferred potential payout, etc.).

In addition to determining a profile for a particular player, information gathered about each player may be used to determine preferences for a particular demographic or group of players. For example, it may be determined that players within the age of 21 to 30 tend to enjoy poker games having a movie game theme, whereas players within the age of 31 to 40 enjoy slots games having a game show theme. Each game profile may therefore be associated with, or otherwise include, the profile(s) of a particular player type(s) that may enjoy playing that particular game. Likewise, each particular player type profile may be associated, or otherwise include, a list of games that such a person may enjoy playing.

Referring again to FIG. 6, once the player preferences have been read from the player profile at block 242, the suggestion routine 203a may compare the player preferences to the game profiles of the games available to play on the gaming unit 20. Such a comparison may be based on a weighted analysis. For example, if a player profile indicates that game theme characteristics are more important than game type characteristics, greater weight may be given to a match, or mismatch, between the player's game theme preferences and the game theme of a particular game. That is, if every characteristic except for the game theme matches the player preferences, the game may not be considered a match for that player. Likewise, even if all characteristics of the game, other than the game theme do not match with the player preferences, the game may still be considered a match for the player because greater weight is given to the game theme. However, those of ordinary skill in the art will recognize that various other criteria may be used to determine whether a match exists or not. For example, it may be required that the game characteristics match each and every player preference, that a majority of the game characteristics match the player preference, that each player preference be considered equally, etc.

Based on the above criteria, a match may be determined at block 244. If a match has been determined, the matching game may be added to a game list at block 245 as a suggested game. If the game being considered was not considered a match at block 244, control may return to block 243 to compare the player preferences to the next available game. Games added to the game list at block 245 may be ranked in terms of degree of match. For example, matches of greater weight (i.e., important preferences) may cause a game to be ranked higher than a game with more overall matches, but fewer matches among the important player preferences. Alternatively, the games may be ranked based purely on the number of matching preferences, without giving greater or lesser weight to any particular player preference. At block 246, the game suggestion routine 203a may determine if all available games have been compared to the player preferences. If so, the game suggestion routine 203a may return to the main operating routine 200, 220. If not, control may pass to block 243 to compare the player preferences to the game profile of the next available game.

Although the above has been described as being part of a main operating routine 200, 220, those of ordinary skill in the art will recognize that aspects of the game suggestion routine 203 may be executed outside of a main operating routine 200, 220 to determine suggested games that a player may enjoy playing, as opposed to determining such games when a player is detected by a gaming unit 20. For example, each time a new player profile and/or game profile is added, a comparison may be performed between the new player profile and the game profiles of all existing games, or between the new game profile and the profiles of all existing players. A list of suggested games that a player may enjoy may thereby be associated with, or otherwise be a part of, each player profile. When a gaming unit 20 identifies a player, as at block 240, and retrieves a player profile, as at block 241, the gaming unit 20 may read the list of previously suggested games and return to the main operating routine 200, 220.

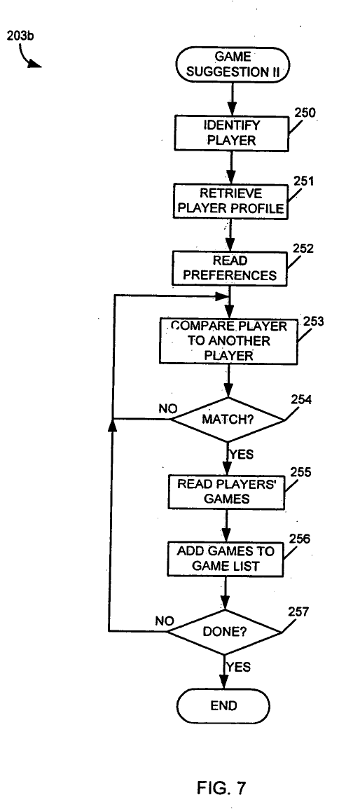

FIG. 7 is a flowchart of a second embodiment of a game suggestion routine 203b that may be stored in the memory of the controller 100 and/or in memory of the network computer 22. The game suggestion routine 203b may be performed during block 203 as shown schematically in FIGS. 4 and 5 to compare player preferences to the preferences of other players to determine which games the player may enjoy playing. Referring to FIG. 7, the game suggestion routine 203b may begin operation at block 250 during which a player is identified by the gaming unit 20. Having identified the player at block 250, the game suggestion routine 203b may retrieve the player's profile at block 251. Player preferences may then be read at block 252. At block 253, the player preferences may be compared to the preferences of other players. Alternatively, the player profile may be compared to the profiles of particular player types at block 253. A player type may relate to a player within a particular demographic(s). A match, or sufficient degree of match, may be determined at block 254 to determine whether the player preferences match those of another player or matches the profile of a particular type player. If not, control may return to block 253 to compare the player's preferences to those of another player or to the profile of another particular player type. If a match does occur, which may or may not be a weighted match similar to that discussed above, the game suggestion routine 203b may read games associated with the profile of another player (or the profile of a particular player type) at block 255. Those games may then be added to a game list at block 256 as suggested games. The game suggestion routine 203b may decide at block 257 whether or not to compare the player profile to that of another player to determine more games to add to the game list. If so, control may return to block 253 to compare the player profile to that of another player or particular player type. If the game list is complete, control may return to the main operating routine 200, 220.

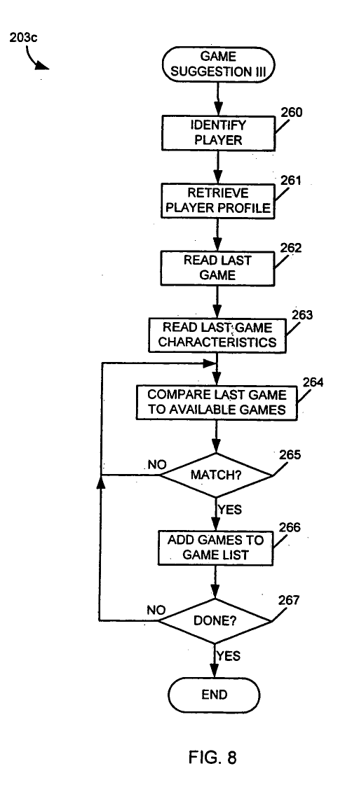

FIG. 8 is a flowchart of a third embodiment of a game suggestion routine 203c that may be stored in the memory of the controller 100 and/or a memory of the network computer 22. The game suggestion routine 203c may be performed during block 203 as shown schematically in FIGS. 4 and 5 to determine games that a player may enjoy based on games previously played by the player, using the assumption that games having a profile or characteristics similar to games previously played by the player, or having frequently been played by the player, would be within the player's interests and preferences. Referring to FIG. 8, the game suggestion routine 203c may begin operation at block 260 during which a player may be identified at a gaming unit 20. Having identified the player, the game suggestion routine 203c may retrieve the player's profile at block 261. Included in the player profile may be last game played by the player, although, as mentioned above, a player profile may further include games played most frequently by the player as well as all games that may have ever been played by the player. Although the present example is described with regard to the last game played by the player, those of ordinary skill in the art will readily recognize that the game suggestion routine 203c may equally be applied to other games that have already been played by the player (e.g., games most frequently played, favorite games as indicated by the player, all games played by the player, etc.).

The game suggestion routine 203c may read the characteristics of a last game from the associated game profile at block 263. At block 264, characteristics of the previously played game may be compared to the characteristics of the available games at block 264. At block 265, the game suggestion routine 203c may determine whether there is a match, or a sufficient degree of match, between the previously played game and the available game being considered. If a match occurs, the available game is added as a suggested game to a game list at block 266. The game previously played by the player, favorite games or frequently played games may be considered automatic matches and added to the game list at block 266. If there is no match, or an insufficient degree of match at block 265, control may pass back to block 264 to compare the previously played game to the next available game. At block 267, the game suggestion routine 202c may determine whether all available games have been compared to the previously played game. If so, control may return to the main operating routine 200, 220. If not, control may return to block 264 to compare the previously played game to other available games.

As mentioned above, those of ordinary skill in the art will recognize that the game suggestion routines 203 may be modified to predict not only which games the player may enjoy but also which game themes, potential payouts, etc. that the player may prefer. As such, the above routines 203 may be used to suggest games or game characteristics such as game theme, pay tables, etc. Once each list(s) of games and/or game characteristics has been determined, the list(s) may be displayed to the player to select a particular game, game theme, payout table or any other game characteristic.

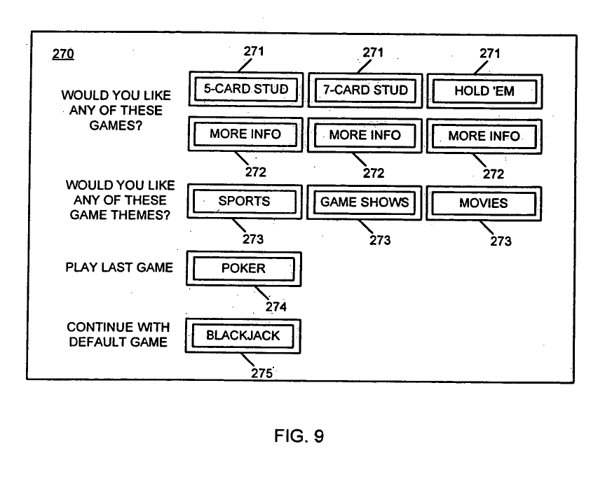

FIG. 9 is an exemplary display 270 that may be shown on the display unit 70 during performance of the main operating routine 200, 220 shown schematically in FIGS. 4 and 5. Referring to FIG. 9, the display 270 may include video images 271 of a suggested game list that may include the games as determined by the game suggestion routine 203. For example, the game routine 203 may have determined that, based on the player profile, the player may enjoy card games, and, in particular, poker games such as five card stud, hold-em and seven card stud. Each of the video images 271 may be provided as a player selectable button to allow the player to select a suggested game. A plurality of player selectable buttons 272 may be associated with each game selection to provide more information about the suggested game (e.g., minimum bet, pay out tables, etc.). Video images 273 may be provided to represent suggested game themes based on the player preferences and presented to the player. The video images 273 may be provided as player selectable buttons to select a particular game theme. The displays 270 may further include a game previously played by the player as represented by a player selectable button 274. Alternatively or in combination, the display 270 may include player selectable buttons to represent all games previously played by the player or favorite games played by the player. A button 275 may be included to represent a default game normally provided by the game unit 20 in the absent of any suggested games, suggested game themes, previously played games, etc. (e.g., if no player identification has been determined, no games have been suggested, no game themes have been suggested, no previous games have been played, etc.). In the present example, the default game is still presented as an option to the player in addition to the suggested games.

### Video Poker

Where the gaming unit 20 is designed to facilitate play of a video poker game, the display unit 70 may comprise a video display unit. FIG. 10 is an exemplary display 350 that may be shown on the display unit 70 during performance of the video poker routine 210 shown schematically in FIG. 4. Referring to FIG. 10, the display 350 may include video images 352 of a plurality of playing cards representing the player's hand, such as five cards. To allow the player to control the play of the video poker game, a plurality of player-selectable buttons may be displayed. The buttons may include a “Hold” button 354 disposed directly below each of the playing card images 352, a “Cash Out” button 356, a “See Pays” button 358, a “Bet One Credit” button 360, a “Bet Max Credits” button 362, and a “Deal/Draw” button 364. The display 350 may also include an area 366 in which the number of remaining credits or value is displayed. If the display unit 70 is provided with a touch-sensitive screen, the buttons 354, 356, 358, 360, 362, 364 may form part of the video display 350. Alternatively, one or more of those buttons may be provided as part of a control panel that is provided separately from the display unit 70.

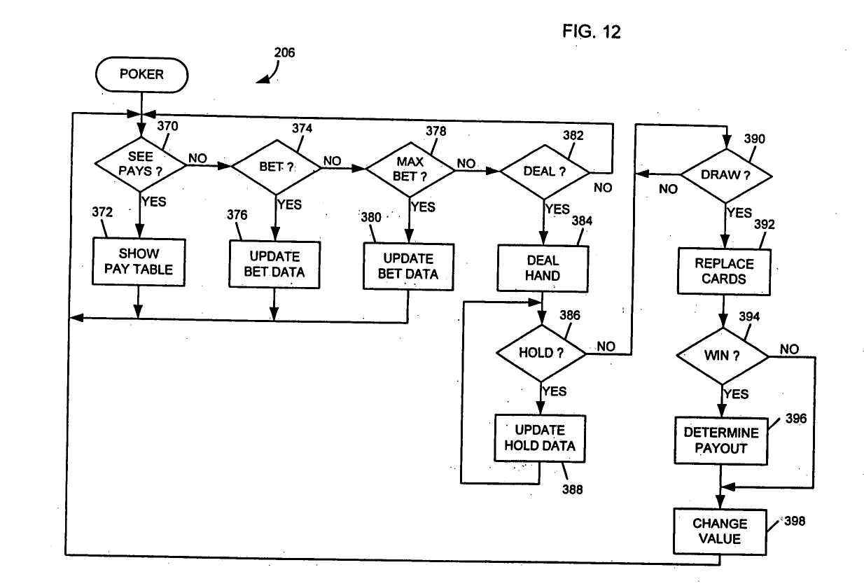

FIG. 12 is a flowchart of the video poker routine 210 shown schematically in FIG. 4. Referring to FIG. 12, at block 370, the routine may determine whether the player has requested payout information, such as by activating the “See Pays” button 358, in which case at block 372 the routine may cause one or more pay tables to be displayed on the display unit 70. At block 374, the routine may determine whether the player has made a bet, such as by pressing the “Bet One Credit” button 360, in which case at block 376 bet data corresponding to the bet made by the player may be stored in the memory of the controller 100. At block 378, the routine may determine whether the player has pressed the “Bet Max Credits” button 362, in which case at block 380 bet data corresponding to the maximum allowable bet may be stored in the memory of the controller 100.

At block 382, the routine may determine if the player desires a new hand to be dealt, which may be determined by detecting if the “Deal/Draw” button 364 was activated after a wager was made. In that case, at block 384 a video poker hand may be “dealt” by causing the display unit 70 to generate the playing card images 352. After the hand is dealt, at block 386 the routine may determine if any of the “Hold” buttons 354 have been activated by the player, in which case data regarding which of the playing card images 352 are to be “held” may be stored in the controller 100 at block 388. If the “Deal/Draw” button 364 is activated again as determined at block 390, each of the playing card images 352 that was not “held” may be caused to disappear from the video display 350 and to be replaced by a new, randomly selected, playing card image 352 at block 392.

At block 394, the routine may determine whether the poker hand represented by the playing card images 352 currently displayed is a winner. That determination may be made by comparing data representing the currently displayed poker hand with data representing all possible winning hands, which may be stored in the memory of the controller 100. If there is a winning hand, a payout value corresponding to the winning hand may be determined at block 396. At block 398, the player's cumulative value or number of credits may be updated by subtracting the bet made by the player and adding, if the hand was a winner, the payout value determined at block 396. The cumulative value or number of credits may also be displayed in the display area 366 (FIG. 10).

Although the video poker routine 210 is described above in connection with a single poker hand of five cards, the routine 210 may be modified to allow other versions of poker to be played. For example, seven card poker may be played, or stud poker may be played. Alternatively, multiple poker hands may be simultaneously played. In that case, the game may begin by dealing a single poker hand, and the player may be allowed to hold certain cards. After deciding which cards to hold, the held cards may be duplicated in a plurality of different poker hands, with the remaining cards for each of those poker hands being randomly determined.

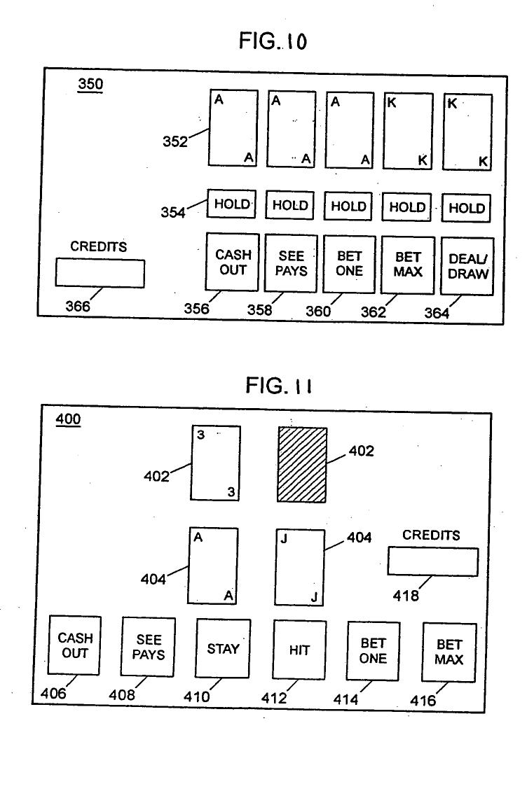

### Video Blackjack

Where the gaming unit 20 is designed to facilitate play of a video blackjack game, the display unit 70 may comprise a video display unit. FIG. 11 is an exemplary display 400 that may be shown on the display unit 70 during performance of the video blackjack routine 220 shown schematically in FIG. 4. Referring to FIG. 11, the display 400 may include video images 402 of a pair of playing cards representing a dealer's hand, with one of the cards shown face up and the other card being shown face down, and video images 404 of a pair of playing cards representing a player's hand, with both the cards shown face up. The “dealer” may be the gaming unit 20.

To allow the player to control the play of the video blackjack game, a plurality of player-selectable buttons may be displayed. The buttons may include a “Cash Out” button 406, a “See Pays” button 408, a “Stay” button 410, a “Hit” button 412, a “Bet One Credit” button 414, and a “Bet Max Credits” button 416. The display 400 may also include an area 418 in which the number of remaining credits or value is displayed. If the display unit 70 is provided with a touch-sensitive screen, the buttons 406, 408, 410, 412, 414, 416 may form part of the video display 400. Alternatively, one or more of those buttons may be provided as part of a control panel that is provided separately from the display unit 70.

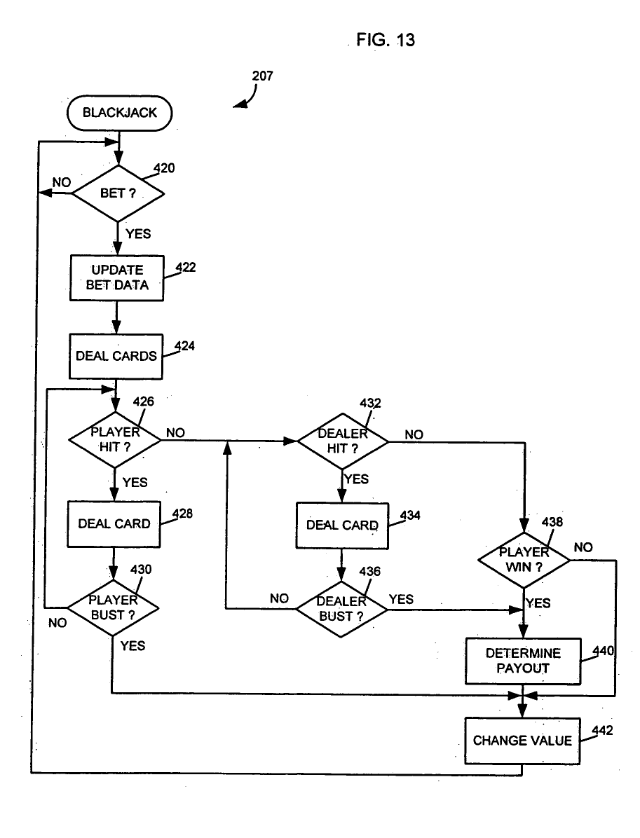

FIG. 13 is a flowchart of the video blackjack routine 220 shown schematically in FIG. 4. Referring to FIG. 13, the video blackjack routine 220 may begin at block 420 where it may determine whether a bet has been made by the player. That may be determined, for example, by detecting the activation of either the “Bet One Credit” button 414 or the “Bet Max Credits” button 416. At block 422, bet data corresponding to the bet made at block 420 may be stored in the memory of the controller 100. At block 424, a dealer's hand and a player's hand may be “dealt” by making the playing card images 402, 404 appear on the display unit 70.

At block 426, the player may be allowed to be “hit,” in which case at block 428 another card will be dealt to the player's hand by making another playing card image 404 appear in the display 400. If the player is hit, block 430 may determine if the player has “bust,” or exceeded 21. If the player has not bust, blocks 426 and 428 may be performed again to allow the player to be hit again.

If the player decides not to hit, at block 432 the routine may determine whether the dealer should be hit. Whether the dealer hits may be determined in accordance with predetermined rules, such as the dealer always hit if the dealer's hand totals 15 or less. If the dealer hits, at block 434 the dealer's hand may be dealt another card by making another playing card image 402 appear in the display 400. At block 436 the routine may determine whether the dealer has bust. If the dealer has not bust, blocks 432, 434 may be performed again to allow the dealer to be hit again.

If the dealer does not hit, at block 436 the outcome of the blackjack game and a corresponding payout may be determined based on, for example, whether the player or the dealer has the higher hand that does not exceed 21. If the player has a winning hand, a payout value corresponding to the winning hand may be determined at block 440. At block 442, the player's cumulative value or number of credits may be updated by subtracting the bet made by the player and adding, if the player won, the payout value determined at block 440. The cumulative value or number of credits may also be displayed in the display area 418 (FIG. 11).

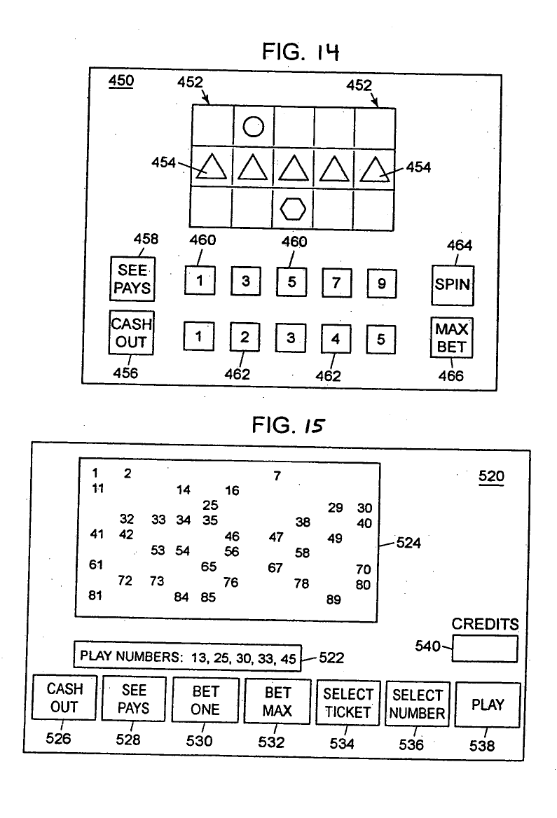

### Slots

Where the gaming unit 20 is designed to facilitate play of a video slots game, the display unit 70 may comprise a video display unit. FIG. 14 is an exemplary display 450 that may be shown on the display unit 70 during performance of the slots routine 230 shown schematically in FIG. 4. Referring to FIG. 14, the display 450 may include video images 452 of a plurality of slot machine reels, each of the reels having a plurality of reel symbols 454 associated therewith. Although the display 450 shows five reel images 452, each of which may have three reel symbols 454 that are visible at a time, other reel configurations could be utilized.

To allow the player to control the play of the slots game, a plurality of player-selectable buttons may be displayed. The buttons may include a “Cash Out” button 456, a “See Pays” button 458, a plurality of payline-selection buttons 460 each of which allows the player to select a different number of paylines prior to “spinning” the reels, a plurality of bet-selection buttons 462 each of which allows a player to specify a wager amount for each payline selected, a “Spin” button 464, and a “Max Bet” button 466 to allow a player to make the maximum wager allowable.

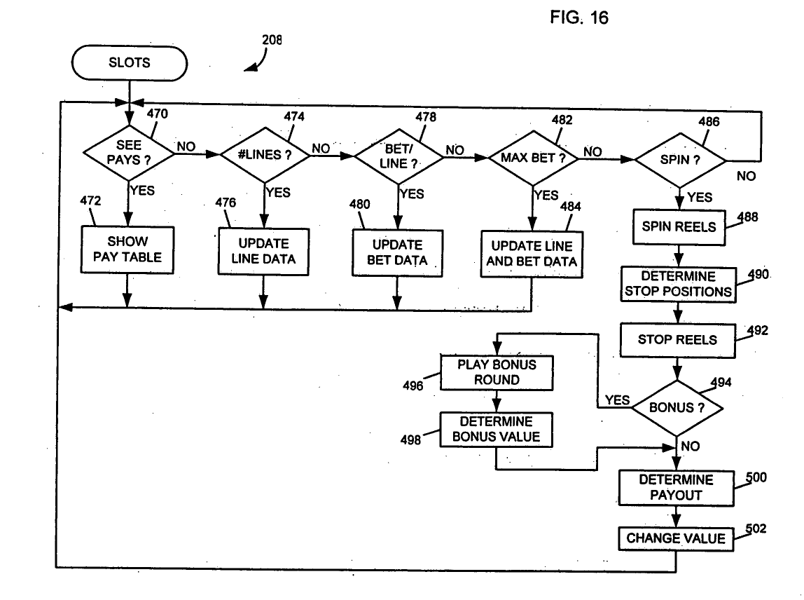

FIG. 16 is a flowchart of the slots routine 230 shown schematically in FIG. 14. Referring to FIG. 16, at block 470, the routine may determine whether the player has requested payout information, such as by activating the “See Pays” button 458, in which case at block 472 the routine may cause one or more pay tables to be displayed on the display unit 70. At block 474, the routine may determine whether the player has pressed one of the payline-selection buttons 460, in which case at block 476 data corresponding to the number of paylines selected by the player may be stored in the memory of the controller 100. At block 478, the routine may determine whether the player has pressed one of the bet-selection buttons 462, in which case at block 480 data corresponding to the amount bet per payline may be stored in the memory of the controller 100. At block 482, the routine may determine whether the player has pressed the “Max Bet” button 466, in which case at block 484 bet data (which may include both payline data and bet-per-payline data) corresponding to the maximum allowable bet may be stored in the memory of the controller 100.

If the “Spin” button 464 has been activated by the player as determined at block 486, at block 488 the routine may cause the slot machine reel images 452 to begin “spinning” so as to simulate the appearance of a plurality of spinning mechanical slot machine reels. At block 490, the routine may determine the positions at which the slot machine reel images will stop, or the particular symbol images 454 that will be displayed when the reel images 452 stop spinning. At block 492, the routine may stop the reel images 452 from spinning by displaying stationary reel images 452 and images of three symbols 454 for each stopped reel image 452. The virtual reels may be stopped from left to right, from the perspective of the player, or in any other manner or sequence.

The routine may provide for the possibility of a bonus game or round if certain conditions are met, such as the display in the stopped reel images 452 of a particular symbol 454. If there is such a bonus condition as determined at block 494, the routine may proceed to block 496 where a bonus round may be played. The bonus round may be a different game than slots, and many other types of bonus games could be provided. If the player wins the bonus round, or receives additional credits or points in the bonus round, a bonus value may be determined at block 498. A payout value corresponding to outcome of the slots game and/or the bonus round may be determined at block 500. At block 502, the player's cumulative value or number of credits may be updated by subtracting the bet made by the player and adding, if the slot game and/or bonus round was a winner, the payout value determined at block 500.

Although the above routine has been described as a virtual slot machine routine in which slot machine reels are represented as images on the display unit 70, actual slot machine reels that are capable of being spun may be utilized instead, in which case the display unit 70 could be provided in the form of a plurality of mechanical reels that are rotatable, each of the reels having a plurality of reel images disposed thereon.

### Video Keno

Where the gaming unit 20 is designed to facilitate play of a video keno game, the display unit 70 may comprise a video display unit. FIG. 15 is an exemplary display 520 that may be shown on the display unit 70 during performance of the video keno routine 240 shown schematically in FIG. 4. Referring to FIG. 15, the display 520 may include a video image 522 of a plurality of numbers that were selected by the player prior to the start of a keno game and a video image 524 of a plurality of numbers randomly selected during the keno game. The randomly selected numbers may be displayed in a grid pattern.

To allow the player to control the play of the keno game, a plurality of player-selectable buttons may be displayed. The buttons may include a “Cash Out” button 526, a “See Pays” button 528, a “Bet One Credit” button 530, a “Bet Max Credits” button 532, a “Select Ticket” button 534, a “Select Number” button 536, and a “Play” button 538. The display 520 may also include an area 540 in which the number of remaining credits or value is displayed. If the display unit 70 is provided with a touch-sensitive screen, the buttons may form part of the video display 520. Alternatively, one or more of those buttons may be provided as part of a control panel that is provided separately from the display unit 70.

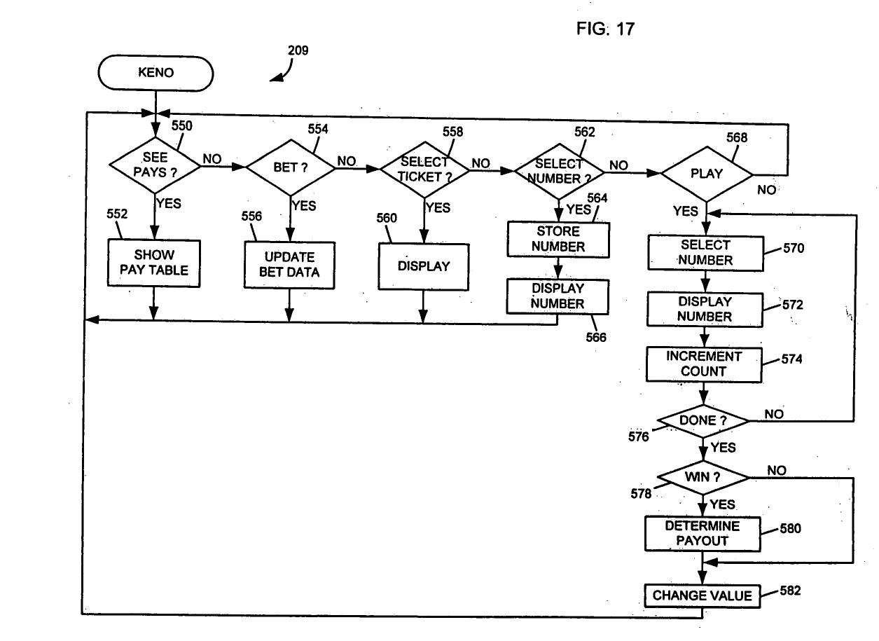

FIG. 17 is a flowchart of the video keno routine 240 shown schematically in FIG. 4. The keno routine 240 may be utilized in connection with a single gaming unit 20 where a single player is playing a keno game, or the keno routine 240 may be utilized in connection with multiple gaming units 20 where multiple players are playing a single keno game. In the latter case, one or more of the acts described below may be performed either by the controller 100 in each gaming unit or by one of the network computer 22, 32 to which multiple gaming units 20 are operatively connected.

Referring to FIG. 17, at block 550, the routine may determine whether the player has requested payout information, such as by activating the “See Pays” button 528, in which case at block 552 the routine may cause one or more pay tables to be displayed on the display unit 70. At block 554, the routine may determine whether the player has made a bet, such as by having pressed the “Bet One Credit” button 530 or the “Bet Max Credits” button 532, in which case at block 556 bet data corresponding to the bet made by the player may be stored in the memory of the controller 100. After the player has made a wager, at block 558 the player may select a keno ticket, and at block 560 the ticket may be displayed on the display 520. At block 562, the player may select one or more game numbers, which may be within a range set by the casino. After being selected, the player's game numbers may be stored in the memory of the controller 100 at block 564 and may be included in the image 522 on the display 520 at block 566. After a certain amount of time, the keno game may be closed to additional players (where a number of players are playing a single keno game using multiple gambling units 20).

If play of the keno game is to begin as determined at block 568, at block 570 a game number within a range set by the casino may be randomly selected either by the controller 100 or a central computer operatively connected to the controller, such as one of the network computers 22, 32. At block 572, the randomly selected game number may be displayed on the display unit 70 and the display units 70 of other gaming units 20 (if any) which are involved in the same keno game. At block 574, the controller 100 (or the central computer noted above) may increment a count which keeps track of how many game numbers have been selected at block 570.

At block 576, the controller 100 (or one of the network computers 22, 32) may determine whether a maximum number of game numbers within the range have been randomly selected. If not, another game number may be randomly selected at block 570. If the maximum number of game numbers has been selected, at block 578 the controller 100 (or a central computer) may determine whether there are a sufficient number of matches between the game numbers selected by the player and the game numbers selected at block 570 to cause the player to win. The number of matches may depend on how many numbers the player selected and the particular keno rules being used.

If there are a sufficient number of matches, a payout may be determined at block 580 to compensate the player for winning the game. The payout may depend on the number of matches between the game numbers selected by the player and the game numbers randomly selected at block 570. At block 582, the player's cumulative value or number of credits may be updated by subtracting the bet made by the player and adding, if the keno game was won, the payout value determined at block 580. The cumulative value or number of credits may also be displayed in the display area 540 (FIG. 15).

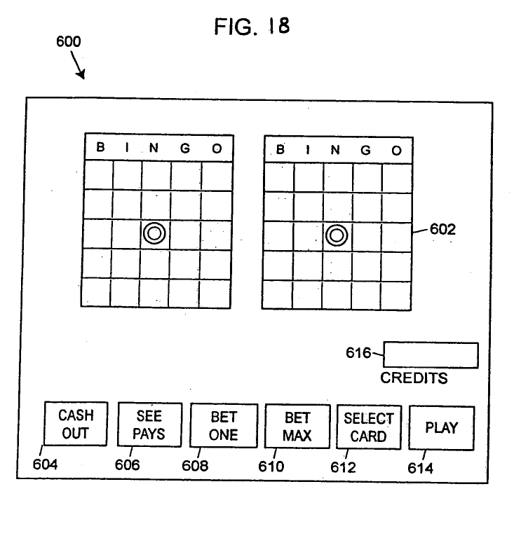

### Video Bingo

Where the gaming unit 20 is designed to facilitate play of a video bingo game, the display unit 70 may comprise a video display unit. FIG. 18 is an exemplary display 600 that may be shown on the display unit 70 during performance of the video bingo routine 250 shown schematically in FIG. 4. Referring to FIG. 18, the display 600 may include one or more video images 602 of a bingo card and images of the bingo numbers selected during the game. The bingo card images 602 may have a grid pattern.

To allow the player to control the play of the bingo game, a plurality of player-selectable buttons may be displayed. The buttons may include a “Cash Out” button 604, a “See Pays” button 606, a “Bet One Credit” button 608, a “Bet Max Credits” button 610, a “Select Card” button 612, and a “Play” button 614. The display 600 may also include an area 616 in which the number of remaining credits or value is displayed. If the display unit 70 is provided with a touch-sensitive screen, the buttons may form part of the video display 600. Alternatively, one or more of those buttons may be provided as part of a control panel that is provided separately from the display unit 70.

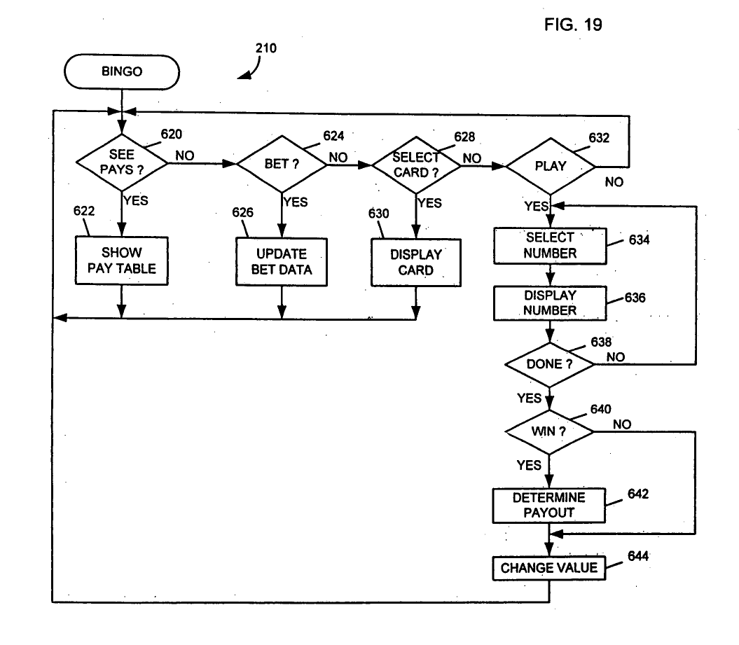

FIG. 19 is a flowchart of the video bingo routine 250 shown schematically in FIG. 4. The bingo routine 250 may be utilized in connection with a single gaming unit 20 where a single player is playing a bingo game, or the bingo routine 250 may be utilized in connection with multiple gaming units 20 where multiple players are playing a single bingo game. In the latter case, one or more of the acts described below may be performed either by the controller 100 in each gaming unit 20 or by one of the network computers 22, 32 to which multiple gaming units 20 are operatively connected.

Referring to FIG. 19, at block 620, the routine may determine whether the player has requested payout information, such as by activating the “See Pays” button 606, in which case at block 622 the routine may cause one or more pay tables to be displayed on the display unit 70. At block 624, the routine may determine whether the player has made a bet, such as by having pressed the “Bet One Credit” button 608 or the “Bet Max Credits” button 610, in which case at block 626 bet data corresponding to the bet made by the player may be stored in the memory of the controller 100.

After the player has made a wager, at block 628 the player may select a bingo card, which may be generated randomly. The player may select more than one bingo card, and there may be a maximum number of bingo cards that a player may select. After play is to commence as determined at block 632, at block 634 a bingo number may be randomly generated by the controller 100 or a central computer such as one of the network computers 22, 32. At block 636, the bingo number may be displayed on the display unit 70 and the display units 70 of any other gaming units 20 involved in the bingo game.

At block 638, the controller 100 (or a central computer) may determine whether any player has won the bingo game. If no player has won, another bingo number may be randomly selected at block 634. If any player has bingo as determined at block 638, the routine may determine at block 640 whether the player playing that gaming unit 20 was the winner. If so, at block 642 a payout for the player may be determined. The payout may depend on the number of random numbers that were drawn before there was a winner, the total number of winners (if there was more than one player), and the amount of money that was wagered on the game. At block 644, the player's cumulative value or number of credits may be updated by subtracting the bet made by the player and adding, if the bingo game was won, the payout value determined at block 642. The cumulative value or number of credits may also be displayed in the display area 616 (FIG. 18).

1. A gaming system comprising:
a network server comprising a gaming server controller comprising a processor and a memory operatively coupled to said processor,
said network server controller being programmed to receive request data relating to a request for a game,
said network server controller being programmed to receive preference data relating to preferences of a first player,
said network server controller being programmed to select a game from a plurality of available games based upon said first player preferences,
said network server controller being programmed to provide said selected game in response to said request,
a gaming apparatus operatively coupled to said network server, said gaming apparatus comprising: a display unit capable of generating video images, a value input device and a gaming apparatus controller comprising a processor and a memory operatively coupled to said processor,
said gaming apparatus controller being programmed to provide said network server with said request data,
said gaming apparatus controller being programmed to receive game selection data relating to said selected game,
said gaming apparatus controller being programmed to cause said display unit to generate a game display relating to said selected game,
said gaming apparatus controller being programmed to determine a value payout associated with an outcome of said selected game.

2. A gaming system as defined in claim 1,
wherein said network server controller is programmed to receive game characteristics data relating to game characteristics of said plurality of available games,
wherein said network server controller is programmed to select an available game by comparing said first player preferences to said game characteristics.

3. A gaming system as defined in claim 1, wherein said network server controller is programmed to select an available game by comparing said first player preferences to preferences of a second player and selecting a game associated with said second player.

4. A gaming system as defined in claim 3, wherein said second player preferences comprises preferences of a particular player demographic.

5. A gaming system as defined in claim 1, wherein said network server controller is programmed to select an available game by comparing a game previously played by said first player to said plurality of available games.

6. A gaming system as defined in claim 1,
wherein said network server controller is programmed to provide previous game data relating to a game previously played by said first player to said gaming apparatus
wherein said gaming apparatus controller is programmed to cause said display unit to generate a game display relating to said previously played game.

7. A gaming system as defined in claim 1,
wherein said gaming apparatus controller is programmed to provide said network server controller with a player identification,
wherein said network server controller is programmed to receive player profile data relating to a player profile associated with said player identification, said player profile data comprising said first player preferences.

8. A gaming system as defined in claim 1,
wherein said network server controller is programmed to select a game characteristic from a plurality of game characteristics based upon said first player preferences to provide a game characteristic selection comprising said selected game characteristic,
wherein said gaming apparatus controller is programmed to cause said display unit to generate a game characteristic selection display relating to said game characteristic selection,
wherein said gaming apparatus controller is programmed to implement a game characteristic from said game characteristic selection in said selected game.

9. A gaming apparatus, comprising:
a display unit;
a value input device;
a controller operatively coupled to said display unit and said value input device, said controller comprising a processor and a memory operatively coupled to said processor,
said controller being programmed to receive preference data relating to preferences of a first player,
said controller being programmed to select a game from a plurality of available games based upon said first player preferences to provide a game selection comprising said selected game,
said controller being programmed to cause said display unit to generate a game selection display relating to said game selection,
said controller being programmed to cause said display unit to generate a game display relating to one of the following games: a game from said game selection, poker, blackjack, slots, keno or bingo,
said controller being programmed to determine a value payout associated with an outcome of said game.

10. A gaming apparatus as defined in claim 9, wherein said display unit comprises a video display unit that is capable of generating video images.

11. A gaming apparatus as defined in claim 10,
wherein said controller is programmed to cause a video image comprising an image of at least five playing cards to be displayed if said game comprises video poker,
wherein said controller is programmed to cause a video image comprising an image of a plurality of simulated slot machine reels to be displayed if said game comprises video slots,
wherein said controller is programmed to cause a video image comprising an image of a plurality of playing cards to be displayed if said game comprises video blackjack,
wherein said controller is programmed to cause a video image comprising an image of a plurality of keno numbers to be displayed if said game comprises video keno,
wherein said controller is programmed to cause a video image comprising an image of a bingo grid to be displayed if said game comprises video bingo.

12. A gaming apparatus as defined in claim 9, wherein said display unit comprises at least one mechanical slot machine reel.

13. A gaming apparatus as defined in claim 9,
wherein said controller is programmed to receive game characteristics data relating to game characteristics of said plurality of available games,
wherein said controller is programmed to select at least one available game by comparing said first player preferences to said game characteristics.

14. A gaming apparatus as defined in claim 9, wherein said controller is programmed to select at least one avaliable game by comparing said first player preferences to preferences of a second player and selecting a game associated with said second player.

15. A gaming apparatus as defined in claim 14, wherein said second player preferences comprises preferences of a particular player demographic.

16. A gaming apparatus as defined in claim 9, wherein said controller is programmed to select at least one available game by comparing a game previously played by said first player to said plurality of available games.

17. A gaming apparatus as defined in claim 9,
wherein said game selection display comprises a display relating to a game previously played by said first player,
wherein said controller is programmed to cause said display unit to generate a game display relating to said previously played game.

18. A gaming apparatus as defined in claim 9,
wherein said controller is programmed to receive identification data relating to the identity of said first player,
wherein said controller is programmed to receive player profile data relating to a player profile associated with said player identity, said player profile data comprising said first player preferences.

19. A gaming apparatus as defined in claim 9,
wherein said controller is programmed to select a game characteristic from a plurality of game characteristics based upon said first player preferences to provide a game characteristic selection comprising said selected game characteristic,
wherein said controller is programmed to cause said display unit to generate a game characteristic selection display relating to said game characteristic selection,
wherein said controller is programmed to implement a game characteristic from said game characteristic selection in said game.

20. A gaming system comprising a plurality of gaming apparatuses as defined in claim 9, said gaming apparatuses being interconnected to form a network of gaming apparatuses.

21. A gaming system as defined in claim 20, wherein said gaming apparatuses are interconnected via the Internet.

22. A gaming apparatus, comprising:
a display unit;
a value input device;
a controller operatively coupled to said display unit and said value input device, said controller comprising a processor and a memory operatively coupled to said processor,
said controller being programmed to receive preference data relating to preferences of a first player,
said controller being programmed to select a game characteristic from plurality of game characteristics based upon said first player preferences to provide a game characteristic selection comprising said selected game characteristic,
said controller being programmed to cause said display unit to generate a game characteristic selection display relating to said game characteristic selection,
said controller being programmed to cause said display unit to generate a game display relating to one of the following games: poker, blackjack, slots, keno or bingo,
said controller being programmed to implement a game characteristic from said game characteristic selection in said game,
said controller being programmed to determine a value payout associated with an outcome of said game.

23. A gaming apparatus as defined in claim 22, wherein said game characteristics comprise payout tables.

24. A gaming apparatus as defined in claim 22, wherein said game characteristics comprise game themes.

25. A gaming apparatus as defined in claim 22, wherein said game characteristics comprise a minimum bet.

26. A gaming apparatus as defined in claim 22, wherein said game characteristics comprise a game type.

27. A gaming apparatus as defined in claim 22, wherein said controller is programmed to select a game characteristic by comparing said first player preferences to said player preferences.

28. A gaming apparatus as defined in claim 22, wherein said controller is programmed to select a game characteristic by comparing said first player preferences to preferences of a second player and selecting a game characteristic associated with said second player.

29. A gaming apparatus as defined in claim 28, wherein said second player preferences comprise preferences of a particular player demographic.

30. A gaming apparatus as defined in claim 22, wherein said controller is programmed to select a game characteristic by comparing a game characteristic of a game previously played by said first player to said plurality of game characteristics.

31. A gaming apparatus as defined in claim 22,
wherein said controller is programmed to select a game from a plurality of available games based upon said first player preferences to provide a game selection,
wherein said controller is programmed to cause said display unit to generate a game selection display relating to said game selection,
wherein said controller is programmed to cause said display unit to generate a game display relating to a game from said selection of games.

32. A gaming system comprising a plurality of gaming apparatuses as defined in claim 22, said gaming apparatuses being interconnected to form a network of gaming apparatuses.

33. A gaming method, comprising:
receiving identification data relating to the identity of a first player;
receiving player profile data relating to a player profile associated with said player identity, said player profile comprising preference data relating to preferences of said first player;
selecting a game from a plurality of available games based upon said first player preferences to provide a game selection;
causing a game selection display relating to said game selection comprising said selected game to be generated;
causing a game display of one of the following games to be generated: a game from said game selection, poker, blackjack, slots, keno or bingo; and
determining a value payout associated with an outcome of said game represented by said video image.

34. A gaming method as defined in claim 33, additionally comprising receiving game characteristics data relating to characteristics of said available game,
wherein selecting a game from a plurality of available games comprises comparing said first player preferences to said game characteristics.

35. A gaming method as defined in claim 33, wherein selecting a game from a plurality of available games comprises:
comparing said first player preferences to preferences of a second player, and
selecting a game associated with said second player.

36. A gaming method as defined in claim 33, wherein selecting a game from a plurality of available games comprises comparing a game previously player by said first player to said available games.

37. A gaming method as defined in claim 33, additionally comprising:
causing a game display relating to a game previously played by said first player to be generated;
causing a game display relating to said previously played game to be generated.

38. A gaming method as defined in claim 33, additionally comprising:
selecting a game characteristic from a plurality of game characteristics based upon said first player preferences to provide a game characteristic selection;
causing a game characteristic selection display relating to said game characteristic selection to be generated;
implementing a game characteristic from said game characteristic selection in said game.
